(19) United States
(12) Patent Application Publication
(10) Pub. No.: US 2005/0120308 A1
(43) Pub. Date: Jun. 2, 2005

(54) Method and system for providing an accessible object on a modal dialog box

(76) Inventors: Becky Jean Gibson, Westford, MA (US); Zhiling Jeanie Zheng, Durham, NC (US)

Correspondence Address: STEUBING AND MCGUINESS & MANARAS LLP, 125 NAGOG PARK, ACTON, MA, 01720, US

(21) Appl. No.: 10/726,048

(22) Filed: Dec. 1, 2003

(51) Int. Cl. G06F 3/00

(52) U.S. Cl. 715/779; 715/809; 715/808; 715/975; 715/705; 715/709; 715/715; 715/778; 715/747

(57) ABSTRACT

A method and system for creating a fully accessible display object is disclosed, that may advantageously be used to provide a fully accessible object within a modal dialog box displayed in association with Web page. A fully accessible object is formed using an image command, and associated parameters, within a document containing formatting information for a user interface. The image command associates a graphical image with an software script event handler used to respond to keyboard actions of the user, such as pressing the enter key, as well as mouse actions, and also enables screen reader program access to the object. The display object formed with the disclosed system may be specifically identified and accessed with respect to the other objects of the modal dialog box through use of a the tab key on the keyboard.

### FIELD OF THE INVENTION

The present invention relates generally to user interfaces, and more specifically to a method and system for providing a fully accessible object on a modal dialog box.

### BACKGROUND OF THE INVENTION

In many graphical user interfaces, visual constructs referred to as “dialog boxes” are used to present information to and/or obtain input from a user for a variety of purposes. In this context, dialog boxes typically appear temporarily within the display screen, disappearing after they have obtained a requested input.

Dialog boxes may be either “modal”, or “non-modal” (a.k.a. “modeless”), with modal dialog boxes being the most common. A modal dialog box changes the mode of input (or “focus”) of a program from a previous display to the dialog box. While a modal dialog box is displayed, the user cannot switch from the modal dialog box to another display object in the same program. The user must explicitly end the dialog box, for example by clicking on a graphical button marked “OK” or “Cancel”. A non-modal dialog box allows the user to switch to another display within the same program, such as the display preceding the dialog box. In many circumstances, it is desirable to use a modal rather than a non-modal dialog box, forcing the user to provide an input, such as an acknowledgement or other type of input, or close the dialog box, before continuing to use the program. In the context of the World Wide Web (“Web”), it is common to use modal dialog boxes within Web pages, providing modal dialogs that keep the focus of the Web browser program in the dialog box until the user explicitly closes the dialog box.

In general, in consideration of users having a range of capabilities and preferences, it is desirable for user interfaces to provide a full range of access options, including mouse, keyboard, and screen reader program accessibility. In particular, visually impaired users may have difficulty using a mouse, and rely on keyboard and screen reader access to interact with a computer. A screen reader program is software that assists a visually impaired user by reading the contents of a computer screen, converting the text to speech. An example of an existing screen reader program is the JAWS® program offered by Freedom Scientific® corporation. Additionally, users other than the visually impaired may not be able to use a mouse, for example as a result of an injury or disability, and may need an interface providing keyboard access as an alternative to mouse access. With the growing importance of content provided over the Web, there is especially a need to provide full keyboard and screen reader access to Web pages, in addition to mouse click access.

HyperText Mark-up Language (“HTML”) is used to format content presented on the Web. The HTML for a Web page defines page layout, fonts and graphic elements, as well as hypertext links to other documents on the Web. A Web page is typically built using HTML “tags” embedded within the text of the page. An HTML tag is a code or command used to define a format change or hypertext link. HTML tags are surrounded by the angle brackets “<” and “>”.

As it is generally known, a common approach to creating clickable objects, such as buttons, on a Web page using HTML is by using an <a> (“anchor”) tag, surrounding an <img> (“image”) tag, defining a graphic image for the object. The <a> tag has an “href=” (“hypertext reference”) attribute, followed by a value, such as a name or URL (Uniform Resource Locator), that defines the action to be taken when a user selects the clickable object by clicking on the graphic image with a mouse. When creating clickable objects in HTML, it may be desirable for the <a> tag to contain an href=“javascript:functionName( )” attribute definition, in order for a JavaScript function to be invoked when the user clicks on the image, rather than navigating to a new URL (Uniform Resource Locator) in response to the click. However, an <a> tag with an href=“javascript:functionName( )” attribute definition cannot conveniently be used in a modal dialog box. This results from the operation of some Web browser programs, which don't recognize the use of a JavaScript value for the href=attribute within a modal dialog. As a consequence, when the user clicks on the object, the program attempts to open a new page, even though the value of the href=attribute is not a URL. An error results reporting that a page was not found, since the JavaScript function call is mistakenly treated as a URL. It is possible to define an event handler to be invoked in response to detection of a click on the object using an “onclick” attribute within the anchor tag. However, this approach requires definition of an href=attribute value that is never called, resulting in confusing and inefficient program code.

Accordingly, in order to create a clickable object that can invoke JavaScript on a modal dialog page, without requiring use of a “dummy” href=attribute value, a different approach must be used. One possibility is using an <img> tag with an “onclick=” event handler. Unfortunately, the onclick=handler alone does not provide keyboard or screen reader support—it only works with a mouse.

For these reasons and others, it would therefore be desirable to have a new system for providing a keyboard and screen reader accessible object within a modal dialog box, that invokes an executable function or program, such as JavaScript. The new system should be applicable to operation in connection with the display of a Web page.

### SUMMARY OF THE INVENTION

In accordance with principles of the invention, a method and system for creating a fully accessible display object are disclosed. The disclosed system may advantageously provide a fully accessible display object within a modal dialog box displayed in association with Web page. The disclosed system forms the display object using an image command, and associated parameters, within a document containing formatting information for a user interface. The image command of the disclosed system includes parameters defining event handlers that respond to keyboard actions of the user, as well as mouse actions, and that enable full screen reader program access to the dialog box containing the toolbar button, including the toolbar button, even within a modal dialog box provided from a Web page. The disclosed system is operable to successfully invoke a call to an executable program in response to selection by the user of the object using the keyboard and/or mouse

In one embodiment, the disclosed image command is an HTML <img> tag, providing a display object definition for a modal dialog box within a Web page. In this embodiment, the <img> tag includes HTML tabindex, onclick, and onkeypress attributes associated with respective event handlers, in order to provide full accessibility. Creating a display object in this way allows the HTML code for the object to invoke JavaScript functions within a modal dialog box provided from a Web page.

In another embodiment, the disclosed system provides multiple display objects within a modal dialog box, where the display objects are each buttons representing alternative actions that otherwise would be performed by clicking on portions of a toolbar. Such buttons may be referred to as “toolbar buttons”. In this embodiment, the user may generate the modal dialog box using a first keyboard operation, toggle through the buttons within the modal dialog box using a second keyboard operation, and then select a current button using another keyboard operation. Such a set of toolbar buttons may, for example, serve as a keyboard accessible alternative to mouse clickable portions of a toolbar.

Thus there is disclosed a new system for providing a display object within a modal dialog box, that is operable to invoke an executable function or program, such as JavaScript. The new system is operable in connection with the display of a Web page, and may be used to provide a set of toolbar buttons that are fully keyboard and screen read program accessible, and that may be used as alternative to mouse accessible portions of a toolbar.

### BRIEF DESCRIPTION OF THE DRAWINGS

In order to facilitate a fuller understanding of the present invention, reference is now made to the appended drawings. These drawings should not be construed as limiting the present invention, but are intended to be exemplary only.

FIG. 1 is a block diagram representation of a screen display showing a modal dialog box resulting from operation of an embodiment of the disclosed system;

FIG. 2 is a flow chart illustrating operation of an embodiment of the disclosed system;

FIG. 3 shows a first code example from an embodiment of the disclosed system; and

FIG. 4 shows a second code example from an embodiment of the disclosed system.

### DETAILED DESCRIPTION OF EXEMPLARY EMBODIMENTS

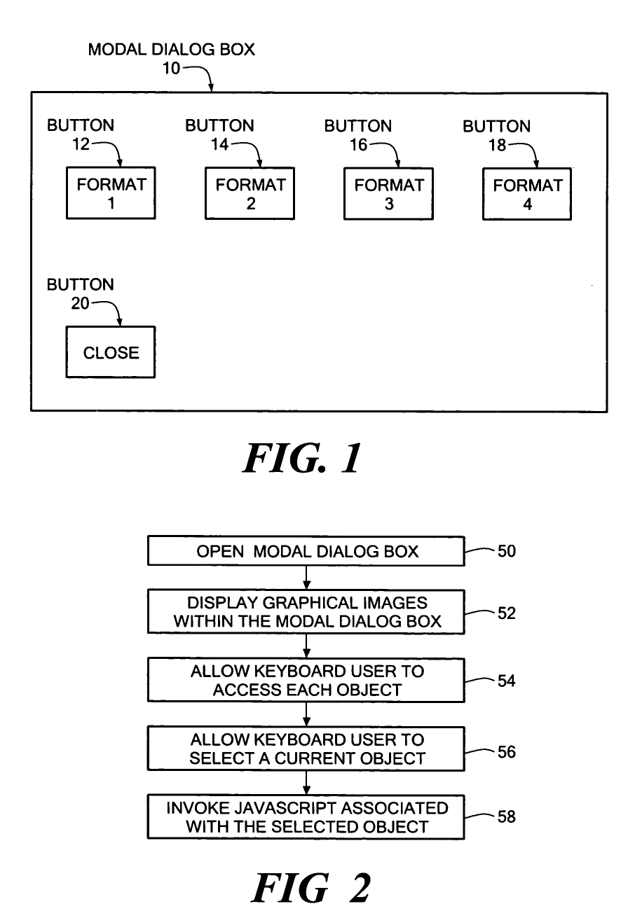

As shown in FIG. 1, for purposes of illustration, a modal dialog box 10 generated using an embodiment of the disclosed system includes a set of graphical images shown as button 12, button 14, button 16, button 18 and button 20. Each of the buttons 12, 14, 16 and 18 are associated with a function that is performed when they are selected by a user. Selection of button 20 by a user causes the modal dialog box 10 to close.

In the illustrative embodiment shown in FIG. 1, each of the buttons 12, 14, 16 and 18 are associated with a different text format, such as bold, italic, underline, etc. The buttons 12, 14, 16 and 18 each display an image that is a graphic representation of the function performed when they are selected. For example, an image displayed on button 12 would represent a first text format, such as a bold character, an image displayed on button 14 would represent a second text format, such as an italic character, an image on button 16 would indicate a third text format such as an underlined character, and an image on button 18 would indicate a fourth text formatting operation, such as the ability to set the text color. Accordingly, the graphic images on the buttons 12, 14, 16, and 18 correspond to the text formatting operations performed in response to selection of the associated button. Accordingly, selection by a user of the button 12 causes a previously determined text selection to be formatted according to a first text formatting operation, such as making the selected text bold, selection of the button 14 causes the text selection to be formatted according to a second text formatting operation, such as making the selected text italic, selection of the button 16 causes the text selection to be formatted according to a third text formatting operation, such as making the selected text underlined, and similarly, selection of the button 18 allows the user to set the color of the selected text. In this way, the disclosed system may be embodied to provide a set of buttons or other graphical display objects within a modal dialog box that provide functions through the modal dialog box that would otherwise require clicking on regions of a toolbar using a mouse. Accordingly, the disclosed system enables the user to preserve a previous operation, such as a text selection, while providing a set of optional operations that are fully accessible to a keyboard and/or screen reader user.

While the modal dialog box of FIG. 1 shows buttons that are operable to change the formatting of a previously determined text selection, these buttons are shown only for purposes of explanation, and the present invention should not be considered as limited to such an embodiment. To the contrary, the present invention is applicable to generating display objects of any specific type within modal dialog boxes, and for performing various associated operations upon user selection of such generated display objects.

FIG. 2 is a flow chart illustrating steps performed by an embodiment of the disclosed system in connection with the modal dialog box 10 of FIG. 1. At step 50 of FIG. 2, the disclosed system operates to open the modal dialog box 10. For example, the disclosed system may allow a user to open the modal dialog box 10 using a predetermined keyboard command, through a key combination, for example combining pressing the control key and another predetermined key. As a result of and in response to detection of this predetermined keyboard operation, the modal dialog box may be opened using any of a variety of techniques, such those that are used to open a new window in a graphical user interface from a Web page.

At step 52, the graphical images within the modal dialog box are displayed in accordance with the present disclosure. Specifically, the buttons 12, 14, 16, 18 and 20 are displayed within the modal dialog box using image commands having attributes defined with appropriate values to permit full accessibility.

At step 54, the disclosed system operates to allow a keyboard user to access each object displayed within the modal dialog box 10. As the user accesses a new object, that object becomes the new current object. An initial current object may be predetermined, such as an object located in the upper left hand corner of the modal dialog box 10.

Specifically, the disclosed system may operate to process tab key presses by the user to move through the buttons 12, 14, 16, 18 and 20. Each time the user presses the tab key, a new one of the buttons 12, 14, 16, 18 and 20 is accessed. As each of the buttons 12, 14, 16, 18 and 20 are accessed in this way, their display may be changed, for example by formation of a second, dotted box (or outline) around the new current one of the buttons 12, 14, 16, 18 and 20, or changing their display in some other way. Further, as each one of the buttons 12, 14, 16, 18 and 20 is accessed in this way, a screen reader program may operate to read information about and/or describing the new current button.

At step 56, the user is allowed to select the current button using a keyboard operation such as pressing the enter key. In response to selection of one of the buttons in the modal dialog box 10, the disclosed system operates to execute an associated program routine, such as a JavaScript function, at step 58. In the example embodiment of FIG. 1, the associated JavaScript function changes the format of the previously selected text to the format associated with the button that was selected. While pressing the enter key may be the keyboard operation detected by the disclosed system to select a current button, other keyboard operations may be used in the alternative, such as detection of the user pressing a key other than the enter key.

FIG. 2 is a flowchart illustration of methods, apparatus (systems) and computer program products according to an embodiment of the invention. It will be understood that each block of the flowchart illustration, and combinations of blocks in the flowchart illustration, can be implemented by computer program instructions. These computer program instructions may be loaded onto a computer having one or more processors, or other programmable data processing apparatus, to produce a machine, such that the instructions which execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

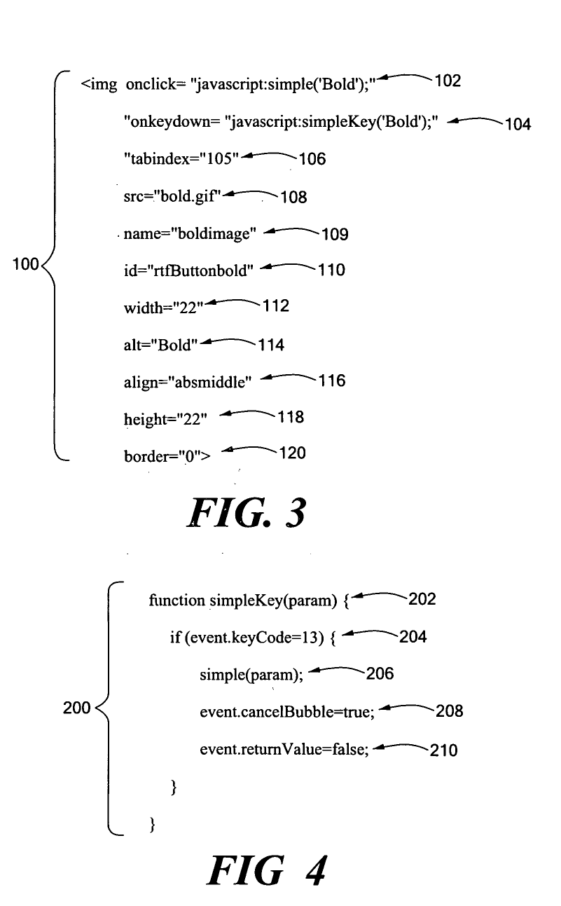

FIG. 3 shows an example of an image command 100 in accordance with an embodiment of the disclosed system. As shown in FIG. 3, the disclosed system may be embodied by providing parameters to attributes within an HTML <img> tag, in order to create one or more accessible display objects within a modal dialog box. The disclosed approach can be used on any HTML page to create an accessible button, or other display object. In this way, the disclosed system enables provision of an accessible graphical object that can invoke program code, such as JavaScript, within a modal dialog box.

The <img> tag 100 of FIG. 3 is shown including an “onclick” attribute 102 with a parameter value of “javascript:simple(‘Bold’)”. In HTML, the parameter of an onclick attribute determines what actions are to be performed on detection of a mouse click performed by a Web browser user. In this case, the onclick parameter “javascript:simple(‘Bold’)” determines the action performed when a user clicks on the graphical display object defined by the image command 100. When a user clicks on the graphical display object defined by the image command 100, the JavaScript function simple is invoked with the parameter ‘Bold’. In the embodiment of FIG. 3, the graphical display object defined by the image command 100 is a button associated with a text formatting function that sets the format of a previously selected text string to bold.

Further in the image command 100, an “onkeydown” attribute 104 is also shown including a parameter value of “javascript:simpleKey(‘Bold’)”. The value of the onkeydown attribute defines the action taken upon detection of a keyboard key being pressed by the user. In the example of FIG. 3, when a user presses a keyboard key when the graphical display object defined by the image command 100 is currently accessed, the JavaScript function simpleKey is invoked with the parameter ‘Bold’. Thus the functional behavior of the graphical display object generated by the image command 100 is the same upon detection of a mouse click or pressing of one or more predetermined keyboard keys.

The image command 100 of FIG. 3 further includes a “tabindex” attribute 106 with a parameter value of an integer number, shown for purposes of explanation in FIG. 3 as the number 105. The HTML tabindex attribute 106 places the graphical display object defined by the image command 100 of FIG. 3 into an object order understood by the Web browser program for a currently active modal dialog box. The position of the graphical display object created by the image command 100 in the object order is determined by the value of the tabindex attribute, in this case 105, where higher values result in a higher position in the order, and lower values result in a lower position in the order. As a result of processing the tabindex attribute 106, the Web browser program includes the graphical display object defined by the image command 100 into a ordered list of objects that can be accessed independently by a user through use of the tab key on the keyboard. Each time the tab key is depressed, a new object is accessed, and becomes the new current graphical display object. When a display object becomes the new current graphical display object, the display of that object may be changed, for example by highlighting the object or providing some other visual indication. Additionally, a screen reader computer program may operate to provide audio indicating the new current object, such as outputting a name associated with the object.

The accessibility of the display object is improved through the addition of the tabindex attribute 106. For example, the Microsoft® Internet Explorer Web browser program automatically tabs through <a> tag elements and any form elements on a page using a “tab order”. Since the an <img> tag is not a form element, it would not automatically be added to the tab order on the page. The disclosed system adds the tabindex attribute 106 to the image command 100 to enable the resulting display object to get focus via pressing of the tab key.

Also shown in the image command 100 of FIG. 3 is a “src” attribute 108 having a parameter value of “bold.gif”. The parameter value of the src attribute 108 defines the graphical image that is displayed for the image command 100. In this case, the “bold.gif” file is a graphics file of a button to be displayed to the user, for example including a visual indication that selection of the button results in bold formatting of previously selected text. The “id” attribute 110 is shown having a parameter value of “rtButtonbold”, defining a code label that can be used to refer to the image command 100 from script or other program code outside the image command 100. The “name” attribute 109 is shown with a parameter value of “boldimage”, also defining a name associated with the image command 100. The “width” attribute 112 has a parameter value of “22” that is used by the Web browser program to size the image for the display object associated with the image command 100. The “alt” attribute defines a title of the display object, in this case “Bold”. The title of the object may be read by a screen reader program, thus identifying the object to a visually impaired user. The “align” attribute 116 provides an alignment of the display object, the “height” attribute 118 determines a height of the display object, and the “border” attribute 120 indicates whether the display object is displayed having a border. Processing of the image command 100 by a Web browser computer program may result in display of one of the button objects 12, 14, 16 or 18 of FIG. 1.

As shown in FIG. 3, the onclick and onkeydown attributes 102 and 104 are event handler attributes that each invoke a JavaScript method as an event handler in response to a detected event. The onclick event handler (simple(‘Bold’)) is invoked by a mouse click on the display object, for example one of the button 12, 14, 16 or 18 of FIG. 1. The onkeydown handler (simpleKey(‘Bold’)) is used to support keyboard access, is responsible for handling the onkey event properly, and invokes the same function as the onclick event handler.

FIG. 4 shows an example embodiment of the simpleKey(param) function 200. As shown in FIG. 4, the body 202 of the simpleKey function 200 checks 204 an event object event.keyCode value. If the value of event.KeyCode is equal to a predetermined value, for example a value “13” indicating the pressing of the return key, then the function simple(param) 206 is invoked to process the parameter “param” passed to simpleKey function 200. In this case, the parameter passed to the simple(param) function is ‘Bold’, indicating that the function simple(param) 206 should operate to set the format of a pre-selected text section to bold. The simple(param) function 206 may perform other operations in response to other parameter values it may be passed. For example, another button used to set the format of pre-selected text to italic might pass. an ‘Italic’ parameter, causing the text format to be set to italic, etc. The statement event.cancelBubble=true 208 sets a flag in the event object indicating that further processing of the keyboard event should not be performed, and the statement event.returnValue=false 210 provides indication that the event has been handled, thus preventing an actual carriage return from being performed. As shown in FIG. 4, the simple(param) function 208 is executed by both the onclick event handler and the onkeydown event handler. This ensures that the key press and the mouse click events result in performance of the same JavaScript operation.

Thus the disclosed system advantageously combines the use of onclick and onkeydown attributes and associated event handlers with a tabindex attribute in an image command. Additionally, the disclosed simpleKey( ) function shows a technique for properly capturing the enter key to invoke the action associated with the display object, thus providing access to a keyboard or screen reader user. Further, the disclosed system solves the problem of creating an accessible display object that can invoke JavaScript within a modal dialog box.

Those skilled in the art should readily appreciate that programs defining the functions of the present invention can be delivered to a computer in many forms; including, but not limited to: (a) information permanently stored on non-writable storage media (e.g. read only memory devices within a computer such as ROM or CD-ROM disks readable by a computer I/O attachment); (b) information alterably stored on writable storage media (e.g. floppy disks and hard drives); or (c) information conveyed to a computer through communication media for example using baseband signaling or broadband signaling techniques, including carrier wave signaling techniques, such as over computer or telephone networks via a modem.

While the invention is described through the above exemplary embodiments, it will be understood by those of ordinary skill in the art that modification to and variation of the illustrated embodiments may be made without departing from the inventive concepts herein disclosed. Moreover, while the preferred embodiments are described in connection with various illustrative program command structures, one skilled in the art will recognize that the system may be embodied using a variety of specific command structures. Accordingly, the invention should not be viewed as limited except by the scope and spirit of the appended claims.

1. A method for creating at least one accessible graphical image within a modal dialog box graphical object, comprising:
providing said modal dialog box graphical object; and
providing said at least one accessible graphical image within said modal dialog box graphical object, wherein said providing said at least one accessible graphical image is responsive to at least one image command, said image command including a first attribute determining the processing of at least one predetermined keyboard event, and a second attribute determining the processing mouse click events, wherein said first attribute and said second attribute have parameters indicating a software routine operable to perform a predetermined function associated with said accessible graphical image.

2. The method of claim 1, wherein said at least one image command further comprises a third attribute having a parameter indicating an ordinal value to be associated with said at least one graphical image, wherein said ordinal value represents a relative position within an ordering of graphical images within said modal dialog box graphical object, whereby a user is allowed to access said at least one graphical image by using a keyboard action resulting in ones of said graphical images within said modal dialog box being sequentially accessed responsive to said ordering of graphical images within said modal dialog box.

3. The method of claim 2, wherein said at least one image command further comprises a fourth attribute having a parameter including text associated with said at least one graphical image, wherein said text is accessible to a screen reader program for conversion to an audio output signal.

4. The method of claim 1, wherein said at least one image command is stored within a document containing formatting information for a user interface, wherein said document is a Web page, and wherein said image command is a tag of a mark-up programming language.

5. The method of claim 1, wherein said at least one predetermined keyboard event comprises detection of a user pressing the enter key.

6. The method of claim 1, wherein said at least one accessible graphical image comprises a plurality of accessible graphical images, wherein each of said accessible graphical images is associated with a respective one of a plurality of predetermined functions, wherein each of said plurality of predetermined functions comprises one of a set of tool bar accessible functions.

7. The method of claim 6, wherein said plurality of predetermined functions comprise text formatting operations, and wherein said software routine operable to perform said predetermined function is further operable to perform an associated one of said text forwarding operations.

8. A computer program product, wherein said computer program product includes a computer readable medium, said computer readable medium having a computer program for creating at least one accessible graphical image within a modal dialog box graphical object stored thereon, said computer program comprising:
program code for providing said modal dialog box graphical object; and
program code for providing said at least one accessible graphical image within said modal dialog box graphical object, wherein said providing said at least one accessible graphical image is responsive to at least one image command, said image command including a first attribute determining the processing of at least one predetermined keyboard event, and a second attribute determining the processing mouse click events, wherein said first attribute and said second attribute have parameters indicating a software routine operable to perform a predetermined function associated with said accessible graphical image.

9. The computer program product of claim 8, wherein said at least one image command further comprises a third attribute having a parameter indicating an ordinal value to be associated with said at least one graphical image, wherein said ordinal value represents a relative position within an ordering of graphical images within said modal dialog box graphical object, said computer program operable to allow a user to access said at least one graphical image by using a keyboard action resulting in ones of said graphical images within said modal dialog box being sequentially accessed responsive to said ordering of graphical images within said modal dialog box.

10. The computer program product of claim 9, wherein said at least one image command further comprises a fourth attribute having a parameter including text associated with said at least one graphical image, wherein said text is accessible to a screen reader program for conversion to an audio output signal.

11. The computer program product of claim 8, wherein said at least one image command is stored within a document containing formatting information for a user interface, wherein said document is a Web page, and wherein said image command is a tag of a mark-up programming language.

12. The computer program product of claim 8, wherein said at least one predetermined keyboard event comprises detection of a user pressing the enter key.

13. The computer program product of claim 8, wherein said at least one accessible graphical image comprises a plurality of accessible graphical images, wherein each of said accessible graphical images is associated with a respective one of a plurality of predetermined functions, wherein each of said plurality of predetermined functions comprises one of a set of tool bar accessible functions.

14. The computer program product of claim 13, wherein said plurality of predetermined functions comprise text formatting operations, and wherein said software routine operable to perform said predetermined function is further operable to perform an associated one of said text forwarding operations.

15. A system for creating at least one accessible graphical image within a modal dialog box graphical object, comprising:
means for providing said modal dialog box graphical object; and
means for providing said at least one accessible graphical image within said modal dialog box graphical object, wherein said providing said at least one accessible graphical image is responsive to at least one image command, said image command including a first attribute determining the processing of at least one predetermined keyboard event, and a second attribute determining the processing mouse click events, wherein said first attribute and said second attribute have parameters indicating a software routine operable to perform a predetermined function associated with said accessible graphical image.

16. The system of claim 15, wherein said at least one image command further comprises a third attribute having a parameter indicating an ordinal value to be associated with said at least one graphical image, wherein said ordinal value represents a relative position within an ordering of graphical images within said modal dialog box graphical object, whereby a user is allowed to access said at least one graphical image by using a keyboard action resulting in ones of said graphical images within said modal dialog box being sequentially accessed responsive to said ordering of graphical images within said modal dialog box.

17. The system of claim 16, wherein said at least one image command further comprises a fourth attribute having a parameter including text associated with said at least one graphical image, wherein said text is accessible to a screen reader program for conversion to an audio output signal.

18. The system of claim 15, wherein at least one image command is stored within a document containing formatting information for a user interface, wherein said document is a Web page, and wherein said image command is a tag of a mark-up programming language.

19. The system of claim 15, wherein said at least one predetermined keyboard event comprises detection of a user pressing the enter key.

20. The system of claim 15, wherein said at least one accessible graphical image comprises a plurality of accessible graphical images, wherein each of said accessible graphical images is associated with a respective one of a plurality of predetermined functions, wherein each of said plurality of predetermined functions comprises one of a set of tool bar accessible functions.

21. The system of claim 20, wherein said plurality of predetermined functions comprise text formatting operations, and wherein said software routine operable to perform said predetermined function is further operable to perform an associated one of said text forwarding operations.

22. A system for creating at least one accessible graphical image within a modal dialog box graphical object, comprising:
program code, stored in a computer readable memory of a computer having at least one processor having access to said memory, for providing said modal dialog box graphical object; and
program code, stored in said memory, for providing said at least one accessible graphical image within said modal dialog box graphical object, wherein said providing said at least one accessible graphical image is responsive to at least one image command, said image command including a first attribute determining the processing of at least one predetermined keyboard event, and a second attribute determining the processing mouse click events, wherein said first attribute and said second attribute have parameters indicating a software routine operable to perform a predetermined function associated with said accessible graphical image.

23. The system of claim 22, wherein said at least one image command further comprises a third attribute having a parameter indicating an ordinal value to be associated with said at least one graphical image, wherein said ordinal value represents a relative position within an ordering of graphical images within said modal dialog box graphical object, whereby a user is allowed to access said at least one graphical image by using a keyboard action resulting in ones of said graphical images within said modal dialog box being sequentially accessed responsive to said ordering of graphical images within said modal dialog box.

24. The system of claim 23, wherein said at least one image command further comprises a fourth attribute having a parameter including text associated with said at least one graphical image, wherein said text is accessible to a screen reader program for conversion to an audio output signal.

25. A computer data signal embodied in a carrier wave, said computer data signal including at least one computer program for creating at least one accessible graphical image within a modal dialog box graphical object, said at least one computer program comprising:
program code for providing said modal dialog box graphical object; and
program code for providing said at least one accessible graphical image within said modal dialog box graphical object, wherein said providing said at least one accessible graphical image is responsive to at least one image command, said image command including a first attribute determining the processing of at least one predetermined keyboard event, and a second attribute determining the processing mouse click events, wherein said first attribute and said second attribute have parameters indicating a software routine operable to perform a predetermined function associated with said accessible graphical image.

26. The computer data signal of claim 25, wherein said at least one image command further comprises a third attribute having a parameter indicating a ordinal value to be associated with said at least one graphical image, wherein said ordinal value represents a relative position within an ordering of graphical images within said modal dialog box graphical object, wherein said computer program is operable to allow a user to access said at least one graphical image by using a keyboard action resulting in ones of said graphical images within said modal dialog box being sequentially accessed responsive to said ordering of graphical images within said modal dialog box.

27. The computer data signal of claim 26, wherein said at least one image command further comprises a fourth attribute having a parameter including text associated with said at least one graphical image, wherein said text is accessible to a screen reader program for conversion to an audio output signal.
